(19) United States
(12) Patent Application Publication
(10) Pub. No.: US 2022/0407090 A1
(43) Pub. Date: Dec. 22, 2022

(54) FUEL CELL CATALYSTS AND STACK

(71) Applicants: NewSouth Innovations Pty Limited, Sydney (AU); Kohodo Hydrogen Energy Pty Ltd, Sydney (AU)

(72) Inventors: Chuan Zhao, Sydney (AU); Yachao Zeng, Sydney (AU); Quentin Meyer, Sydney (AU); Richard Gondosiswanto, Sydney (AU); Shiyang Liu, Sydney (AU)

(21) Appl. No.: 17/859,337

(22) Filed: Jul. 7, 2022

Related U.S. Application Data
(63) Continuation of application No. PCT/AU2021/050016, filed on Jan. 11, 2021.

(30) Foreign Application Priority Data
Jan. 11, 2020 (AU) 2020900074

(51) Int. Cl. H01M 8/0297; H01M 8/0267; H01M 8/0271; H01M 8/24

(52) U.S. Cl. CPC H01M 8/0297; H01M 8/0267; H01M 8/0271; H01M 8/24

(57) ABSTRACT

Disclosed is an improved fuel cell apparatus. The fuel cell apparatus comprises at least one fuel cell, the fuel cell comprising two bipolar plates (200a 200b), one providing an anode side, and the other providing a cathode side, the fuel cell being configured to have a fuel inlet and a fuel outlet, and a membrane electrode assembly (422) disposed between the fuel inlets (201) and fuel outlets (203) of the bipolar plates. The at least one fuel cell is retained by a housing, the housing comprising a first outer plate and a second outer plate, each located on an opposite face of the at least one fuel cell. The housing further comprises a cooling element support which is adapted to support one or more fans that are adapted to provide an air flow toward the at least one fuel cell.

### TECHNICAL FIELD

This disclosure relates to fuel cells, in particular, proton-exchange membrane fuel cells. More particularly, it relates to improvements in the assembly of fuel cell, as well as the catalyst used for the fuel cell.

### BACKGROUND ART

Sustainable energy production is a key challenge for the transition to a clean energy future. In order to displace fossil fuels in transport applications, it is critical to transition to the use of high density, renewable fuels, such as hydrogen. While hydrogen can be utilised within an internal combustion engine, as a direct substitute for oil-derived fuels, fuel cells are capable of producing energy from hydrogen at a much higher efficiency. In order to find acceptance in transport applications, it is critical to produce fuel cells which are simple, safe and highly efficient.

It is to be understood that, if any prior art is referred to herein, such reference does not constitute an admission that the prior art forms a part of the common general knowledge in the art, in Australia or any other country.

### SUMMARY

In a first aspect, the invention provides fuel cell apparatus, comprising: at least one fuel cell which comprises two bipolar plates one providing an anode side, and the other providing a cathode side, the fuel cell being configured to have a fuel inlet and a fuel outlet, and a membrane electrode assembly disposed between the fuel inlets and fuel outlets of the bipolar plates. The at least one fuel cell is retained by a housing, the housing comprising a first outer plate and a second outer plate, each located on an opposite face of the at least one fuel cell. The housing further comprises a cooling element support which is adapted to support one or more fans that are adapted to provide cooling air flow for the at least one fuel cell.

The assembly can have a stack of multiple fuel cells.

The cooling element support is adapted to be disposed in a transverse orientation to the first and second outer plates, by being attached to each of the first and second outer plates, along a first edge portion of the first outer plate and a first edge portion of the second outer plate.

The cooling element support, or the first edge portions of the first and second outer plates, or both, can be provided with elongated attachment apertures.

The housing can further comprise guide portions, one on either side of the cooling element support, the guide portions defining a location therebetween for the placement of the fuel cell.

The guide portions can be adapted to be oriented transverse to the outer plates, by being attached along second and third edge portions of the outer plates, the second and third edge portions being each adjacent to the first edge portions.

The guide portions or the outer plates at the second and third edge portions thereof, can be provided with elongate attachment apertures.

At least one or more of the bipolar plates can include a plurality of air channels arranged to receive an air flow, said air channels being generally in axial alignment with said air flow, each air channel having a cross section defined at least in part by a width.

The air channels can be provided on a cathode side of the plate.

Adjacent air channels can be separated by a landing, the landing having a width which is one to two times of the width of the air channels.

A width to depth ratio of the cross section of each air channel can be between 1:1 and 1:2.5.

At least one or more of the bipolar plates can include recesses which define a fuel flow field defined between the inlet and outlet.

The fuel flow field can be located on an anode side of the plate.

The fuel flow field can comprise a plurality of flow channels extending in a direction transverse to a direction of the air flow direction from the one or more fans.

Adjacent ones of the flow channels can be separated by a landing, the landing having a width which is one to two times of a width of the flow channels as measured transversely across the flow channels.

The flow channels may be distinct from one other, that is, they are not connected with each other.

Alternatively, at least some of the flow channels can be parts of a continuous channel which includes one or more turns or bends.

The or each fuel cell can include a gasket assembly located between the bipolar plate. The gasket assembly can include an anode gasket adapted to be attached to the anode side, and a cathode gasket attached to be attached to the cathode side.

The gasket assembly can further include reinforcement layers between the anode gasket and the anode side to avoid bending of the anode gasket over the fuel flow field.

The one or more alignment gaskets can be provided between the anode and the cathode gaskets

The gasket assembly can include one or more alignment gaskets, each having two sides, each side having an adhesive or bonding material.

Each bipolar plate can include attachment openings arranged adjacent the fuel inlet and attachment openings arranged adjacent the fuel outlet.

The membrane electrode assembly can comprise a catalyst material which is non precious-metal based. The catalyst material can be deposited onto a matrix by spraying or slurry coating.

The catalyst can be a polyaniline (PANI)-derived catalyst with dual active centre.

The catalyst includes cerium. The cerium may be included as a free radical scavenger or as a pore forming agent, or both.

The catalyst can be PANI-FeₓCe—N—C.

The catalyst can be pyrolyzed at a temperature between approximately 700 and 100 degrees Celsius.

The catalyst can be pyrolyzed at 900 degrees Celsius.

### BRIEF DESCRIPTION OF THE DRAWINGS

Embodiments will now be described by way of example only, with reference to the accompanying drawings in which

FIG. 1 is an exploded perspective view of an improved fuel cell assembly, in accordance with an embodiment of the present invention;

FIG. 2 is a partial perspective view of a plurality of graphite plates provided in a stack, with the air channels visible;

FIG. 3 is a partial perspective view of a graphite plate, depicting the flow fields;

FIG. 4 is an exploded perspective view of a fuel cell assembly;

FIG. 5. Panel (a) is a transmission electron microscopy (TEM) image of PANI-Fe—N—C-900; Panel (b) is a TEM image of PANI-FeCe—N—C-900; Panel (c) is a high-angle annular dark-field scanning transmission electron microscopy (HAADF-TEM) image of PANI-Fe—N—C-900; Panel (d) is a HAADF-TEM image of PANI-FeCe—N—C-900;

FIG. 6. Panel (a) shows the oxygen-reduction reaction (ORR) polarization curves in O₂-saturated 0.5 M H₂SO₄ solution at a scan rate of 10 mV/s and rotation speed of 900 rpm; Panel (b) shows the Tafel plot of Pt/C imposed over those of the PGM-free catalysts; Panel (c) shows the Specific activity and E_{1/2} at 0.7 V. Panel (d) shows the H202 yield and electron transfer numbers of the various catalysts; Panel (e) shows the results from the catalyst stability evaluation by chronoamperometry at 0.5 V for 9000 seconds; Panel (f) shows results from the methanol tolerance evaluation by chronoamperometry at 0.5 V and adding 1 M methanol at 300 s, under the test conditions: O₂-saturated 0.5 M H₂SO₄, 900 rpm, scan rate of 10 mV/second and catalyst loading of 600 μg cm⁻²for PANI-derived catalysts or 60 μgPt cm⁻² for Pt/C, graphite plate as counter electrode;

FIG. 7. Panel (a) shows the ORR polarization curves in O²-saturated 0.1 M KOH solution at a scan rate of 10 mV/second and a rotation speed of 900 rpm; Panel (b) shows the Tafel plot of Pt/C imposed over those of the PGM-free catalysts referred to in FIG. 7(a); Panel (c) shows the Specific activity and E_{1/2} at 0.8 V. Panel (d) shows the H202 yield and electron transfer numbers of the various catalysts; Panel (e) shows the results from the catalyst stability evaluation by chronoamperometry at 0.5 V for 9000 seconds; Panel (f) shows results from the methanol tolerance evaluation by chronoamperometry at 0.5 V and adding 1 M methanol at 300 second. Test conditions: O₂-saturated 0.1 M KOH, 900 rpm, scan rate of 10 mV/second and catalyst loading of 600 μg cm⁻² for PANI-Fe—N—C-900 catalysts or 60 μg Pt cm⁻² for Pt/C, graphite plate as counter electrode;

FIG. 8. Panel (a) shows the electrochemical surface area as a function of the reversible hydrogen electrode (RHE), of the PANI-Fe—N—C-900 by linear fitting of the current density at 0.95 V; Panel (b) shows the cyclic voltammetry of the PANI-Fe—N—C-900 catalyst in N₂-saturated 0.5 M H₂SO₄ at different scan rates; Panel (c) shows the electrochemical surface area as a function of RHE, of the

PANI-Fe₂Ce—N—C-900 by linear fitting of the current density at 0.95 V; Panel (d) shows the cyclic voltammetry of PANI-Fe₂Ce—N—C-900 in N₂-saturated 0.5 M H₂SO₄ at different scan rates; Panel (e) shows the electrochemical surface area as a function of the RHE, of the PANI-FeCe—N—C-900 by linear fitting of the current density at 0.95 V; Panel (f) shows the cyclic voltammetry of PANI-FeCe—N—C-900 in N₂-saturated 0.5 M H₂SO₄ at different scan rates;

FIG. 9 depicts the cyclic voltammetry of PANI-derived ORR catalysts in N₂-saturated (dash-line) and O₂-saturated (solid line) 0.5 M H₂SO₄, at a scan rate: 50 mV/second, and at a cell temperature of 25° C.;

FIG. 10 depicts an alternative fuel flow field having a double serpentine flow channel, in accordance an embodiment of the invention; and

FIG. 11 depicts an alternative fuel flow field having a serpentine flow channel, in accordance an embodiment of the invention.

### DETAILED DESCRIPTION

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

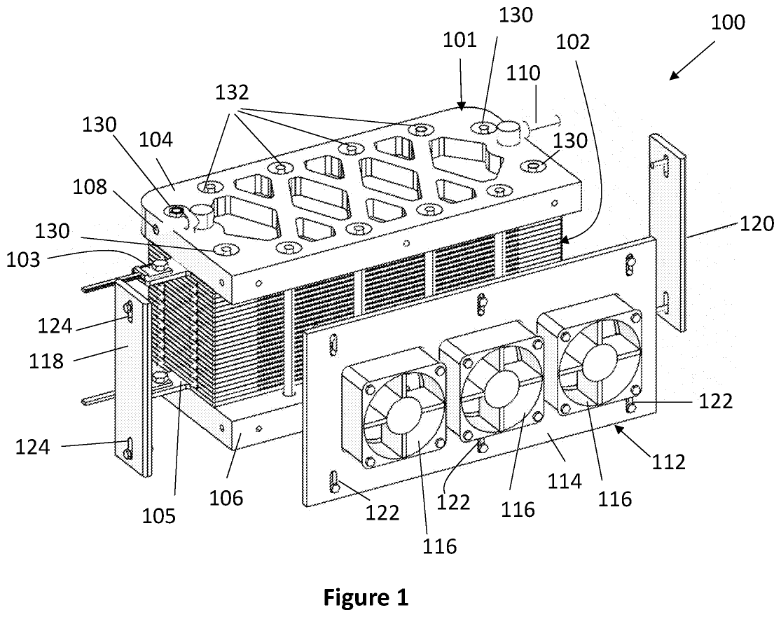

FIG. 1 depicts a fuel cell assembly 100 provided in accordance with an embodiment of the invention, having an open-cathode, air-cooled stack of one or more fuel cells. The fuel cell assembly 100 comprises a fuel cell housing 101, and a fuel cell or a plurality of fuel cells 102 which are connected in series with each other, which are positioned within the housing 101. Contacts 103, 105, e.g., connected to the stack of fuel cell or fuel cells 102 allows the collection or drawing of the current produced by the stack 102 by a load (not shown).

The housing 101 comprises outer plates 104, 106 arranged in parallel to each other, one positioned on each side of the fuel cell stack. The fuel cells 102 are therefore sandwiched between two outer plates 104, 106. The housing 101 provides a fuel inlet 108. The fuel undergoes reduction-oxidisation (“redox”) reactions in the fuel cell. Thus, the housing 101 further provides an outlet 110 for the by-product or exhaust of the redox reactions. In FIG. 1, both the fuel inlet 108 and the exhaust outlet 110 are provided on the same outer plate 104, 106.

The housing 101 further includes a cooling element 112 provided around the fuel-cell stack 102. The cooling element 112 is disposed to connect between the two parallelly-arranged outer plates 104, 106, to at least partially surround perimeter of the outer plates 104, 106, so as to partially enclose separation between the outer plates 104, 106. The cooling element 112 includes a fan support 114 which is arranged to support one or more fans or air blowers 116 which will in use provide cooling air flow into the fuel cell stack 102, to provide dry air to regulate heat in the stack. For instance, the fan support 114 includes cut-outs dimensioned to accommodate the fans. The fan support 114 is preferably positioned so that the air flow is generally perpendicular to the direction of the fuel flow in the fuel cells 102.

On either end of the fan support 114, there is provided a guide portion 118, 120. The fan support 114 can therefore also be considered to be a central portion of the cooling element 112. The guide portions 118, 120 are also attached to the outer plates 104, 106, so that they are located across the gap between the top plates 104, 106. In the depicted configuration, one guide portion 118 is located on the side of the fuel inlet 108, and the other guide portion 120 is located on the side of the by-product or exhaust outlet 110. In the preferred configuration, when assembled, the guide portions 118, 120 are positioned so that the direction of fuel flow generally extends between the guide portions 118, 120.

Referring back to FIG. 1, the cooling element 112 includes the central portion 114 and the side guide portions 118, 120. The central and side portions 114, 118, 120 are attached to both of the outer plates 104, 106, and help to ensure that the fuel cell stack 102 will be correctly aligned with respect to the housing 101. In some embodiments, to enable the attachment, the cooling element 112 will include attachment apertures 122, 124 to allow securing means such as screws, bolts, and the like, to attach the cooling element 112 to the outer plates 104, 106 of the housing 101. In this example, these include attachment apertures 122 on the central portion 114, and the attachment apertures 124 on the side portions 118, 120. Preferably, the apertures 122 and 124 are elongate in shape rather than circular. This allows adjustability in the attachment position of the outer plates 104, 106 in relation to the cooling element 112. The adjustability provide room for compressing the outer plates 104, 106, and hence the fuel stack 102. The cooling element 112 therefore provides a structural element of the housing 101.

The inclusion of the cooling element 112 as part of the housing 101 further improves the strength of the fuel cell assembly 100.

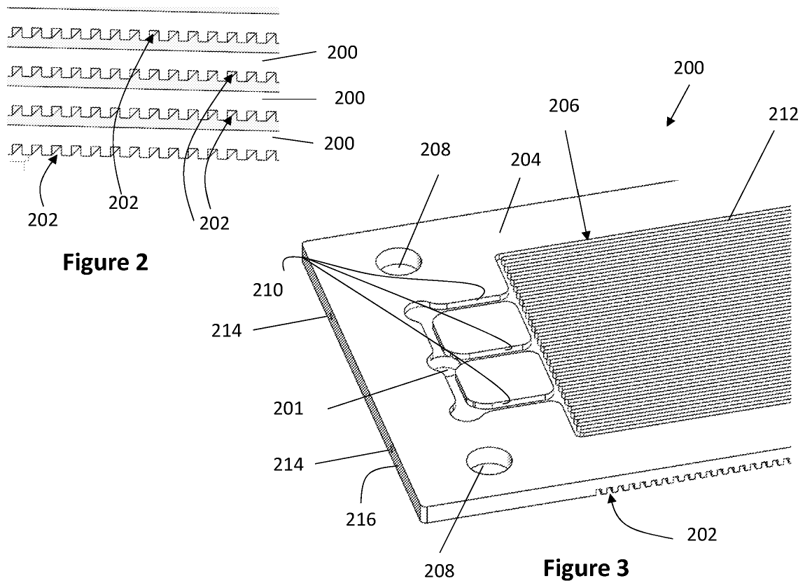

When the fuel cell stack 102 is in proper alignment with the housing 101, it will also be positioned to be in alignment with the fans for efficient cooling. In preferred embodiments where the plates 200 of the fuel cells 102 include air channels 202 (see FIG. 2 and FIG. 3), the air channels 202 will align, or be parallel, with the axis of the fans 116, to maximize the airflow into the air channels 202. By directing the cooling air into the air channels 202 with no or minimal air deflection, the structure also helps to enable the optimisation of the distance between the fans and the fuel stack, for optimal cooling performance.

Currently, in the prior art, cooling elements provide blowers which are spaced from the stack by about 2 centimetres (cm). The housing design in accordance with the present invention allows this distance to be adjusted. In one embodiment the gap can be reduced to 1 cm or less, such as 0.8 cm. This helps to reduce the power consumption of the fans.

The cooling element 112 is preferably dimensioned so that it provides a tight fit with the other components of the fuel cell assembly 100, such as the plates of the fuel cells 102 and the current collectors 103, 105. It is also preferably dimensioned to provide gas tightness with the outer plates 104, 106. The efficiency of the heat regulation can thus be further improved, because the side portions 118, 120 of the cooling element 112 closes some of the potential areas where the air from the fan(s) can leak from the housing 101.

FIG. 2 partially depicts an example of a stack of graphite bipolar plates 200 included in a fuel cell, to show features of flow fields included in the plate. In this view, each plate 200 is shown to include a plurality of air channels 202, extending in the direction of the air flow from the fan(s). The air-channels 202 can be seen in FIG. 3 to open into the cathode side 204 of the plate 200. In one embodiment, the air-channels are each provided with a cross section of 1 millimetre (mm) width and 1 mm height, and adjacent air-channels are spaced apart by 1 mm. The aspect ratio of the channel cross section is adjustable. For instance, the width to depth ratio can be between 1:1 and 1:2.5.

However, depending on the application of the fuel stack, the dimension of the air channels may vary. For instance, the channel width may be increased up to around 2.5 mm, in applications where a greater air flow rate is required. The channel depth may also be increased similarly. In preferred embodiments, there is a one-to-one ratio of channel depth and channel width. However different ratios may be used.

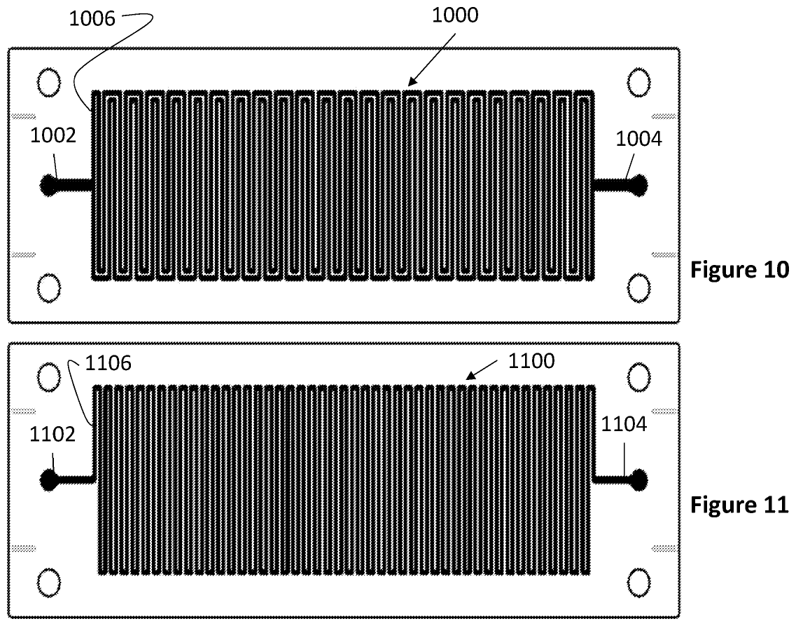

FIG. 3 partially depicts a graphite bipolar plate 200, from a perspective where the anode side 204 is visible. The anode side 204 includes fuel flow fields 206, substantially provided as blind openings or recesses into the anode side 204. An aperture 201 is provided through the thickness of the plate 200. The aperture 201 is located so as to communicate with the flow fields 206, to allow ingress of the fuel into the flow fields 206. In one configuration, from the fuel ingress aperture 201, the flow fields 206 includes one or more of parallel inlet path 210. Three are shown in FIG. 3. Akin to a manifold, the inlet paths 210 feed into a plurality of parallel flow channels 212, there being more flow channels 212 than inlet paths 210. The flow channels may be 1 mm in depth and width, and may be separated from adjacent flow channels by 1 mm. The inlet paths 210 and the flow channels 212 are perpendicular to the air channels 202. Alternative flow fields may be used. Two examples of alternative flow fields are provided in FIGS. 10 and 11.

The flow fields 206 may be etched or cut into the anode side 204, using techniques such as, but not limited to, laser or water-jet cutting, drilling, milling. Additional through apertures 208 may be provided for two or more bipolar plates 200 to be secured together in a stack, or be secured to the housing, or both.

Optionally, the plate 200 further includes apertures 214 for the attachment of sensors, such as voltage sensors or current sensors, to the plate 200. For the sensors to not interfere with the fuel cell stack, they are connected to the side edge(s) of the plate 200. The apertures 214 are therefore provided into the side edge 216 of the plate 200, between the two faces of the plate 200. The sensor attachment apertures 214 may be provided adjacent the fuel inlet end or the fuel outlet end of the plate, or both.

The following dimensions and description in relation to the flow fields 206 and the air channels 202 are provided by way of example only. In this example, the air channels 202 are provided parallel to each other, and are each approximately 1 mm in depth and in width. The flow fields 206 include three independent fuel inlet pathways for the hydrogen, and fuel flow channels of 1 mm depth and width, separated by 1 mm land between the channels. The number of inlets and channels included in the flow fields 206 are not limiting factors, and a different number of channels or openings may be included.

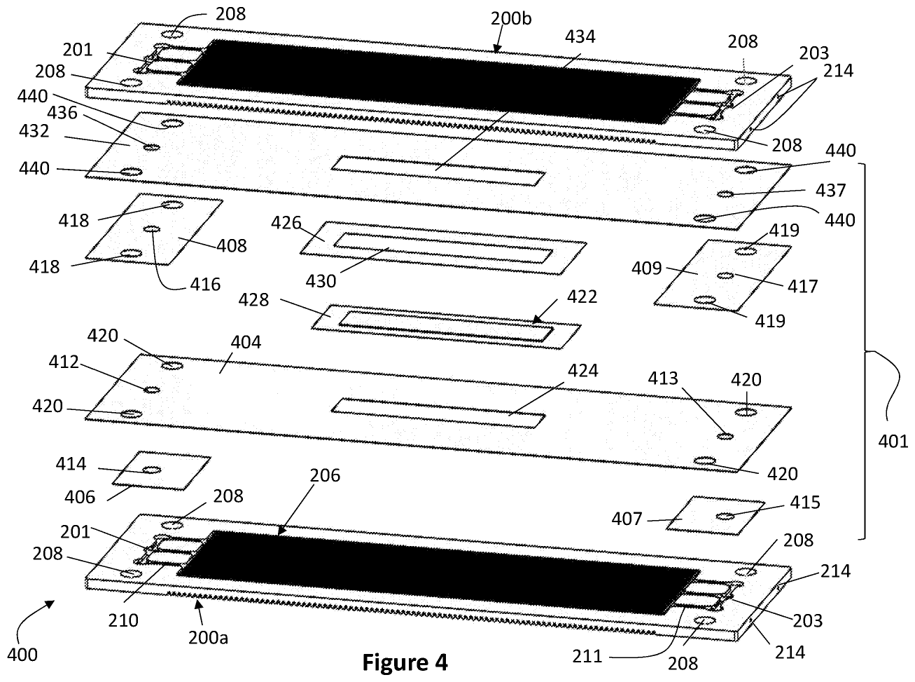

FIG. 4 depicts a fuel cell assembly 400 in an exploded perspective view. In a fuel cell stack, there may be a single fuel cell assembly. Alternatively, multiple fuel cell assemblies 400 may be combined to form the stack. The plates located at the either end of the stack need not provide both the anode fuel flow field and the cathode air channels. The plate located at one end of the stack may only have the cathode side air channels, and the plate located at the opposite of the stack may only include the anode side fuel flow fields. For the intervening plates, one side of the bipolar plate 200 is the “anode” side 204 for one fuel cell and has the anode side fuel flow fields, and the opposite side of the bipolar plate 200 is the “cathode” side for the next fuel cell and has the cathode side air channels.

In FIG. 4, the fuel cell assembly includes two graphite plates 200a, 200b. A gasket arrangement 401 and the membrane electrode assembly 422 are placed between the anode side of one bipolar plate 200a and the cathode side of the other bipolar plate 200b. The gasket arrangement 401 includes an anode gasket layer 404 adjacent the fuel flow fields 206 of the plate 200a, and a cathode gasket layer 432 adjacent the air channels (not shown) of the other plate 200b. The anode gasket layer 404 provides gas sealing to reduce leakage of the fuel from the fuel flow fields 206. The cathode gasket layer 432 provides air sealing to reduce leakage of the air from the air channels. The gasket layers 404, 432 may be generally or approximately co-extensive with the bipolar plates 200a, 200b.

The anode gasket layer 404 includes an aperture 414 which will align with the fuel ingress aperture 201 provided on the bipolar plate 200a, and a further aperture 413 which will align with the fuel egress aperture 203 provided on the bipolar plate 200a, when properly assembled. It may also include attachment apertures 420 which are adapted to align with attachment apertures 208 in the bipolar plate 200a. There is a generally centrally located aperture or cut-out 424, to allow communication between the flow fields 206 and the membrane electrode assembly 422 of the fuel cell. Thus by controlling the dimension of the anode gasket 404, its central aperture 424, or both, the diffusion area from the flow fields 206 to the membrane electrode 422 can be controlled.

Similarly, the cathode gasket layer 432 includes an aperture 436 which will align with the fuel ingress aperture 201 provided on the bipolar plate 200b, and a further aperture 437 which will align with the fuel egress aperture 203 provided on the bipolar plate 200b, when properly assembled. It may also include attachment apertures 420 which are adapted to align with attachment apertures 208 in the bipolar plate 200b. There is a generally centrally located aperture 434, which may be a cut-out, to allow communication between the flow fields 206 and the membrane electrode assembly 422 of the fuel cell assembly 400. The central aperture 434 will be sized and located to align with the cooperating aperture 424 provided on the anode gasket 404. The anode gasket 404 and the cathode gasket 432 may be identical to each other.

The anode gasket layer 404 and the cathode gasket layer 432 are adapted to be attached or bonded to the bipolar plates 200a, 200b, respectively. For instance, the gasket layers 404, 432 may each have a bonding material (such as an adhesive) on the side which is adapted to come into contact with the bipolar plate 200a, 200b.

In some embodiments, reinforcement layers or sheets 406, 407 are included between the anode gasket layer 404 and the bipolar plate 200a, particularly over the ingress to the flow field area and the egress from the flow field area, respectively, to enhance the rigidity and seal over these portions. The reinforcement sheets 406, 407 are held in place by the attachment between the anode gasket 404 and the plate 200a. In some embodiments, the anode gasket layer 404 is made of a material which is not of sufficient rigidity to span over the fuel inlet paths or over the fuel outlet paths without bending, particularly if the fuel inlet and outlet paths are 2 mm in width, or wider. In these embodiments, this reinforcement may be required. Further reinforcement sheets may be provided between the cathode gasket layer 432 and the bipolar plate 200b, if the sizes of the air channels are large enough that the cathode gasket layer 432 does not have enough rigidity to securely seal the channels.

The reinforcement sheets 406, 407 are made from a rigid, water impermeable material, such as stainless steel. In embodiments where the main gasket layer 404 is made of a sufficiently rigid material (e.g., fibreglass), the reinforcements sheets 406, 407 are not necessary.

In the depicted example, the reinforcement sheets 406, 407 is provided over the fuel ingress openings 201, 412. Therefore, the reinforcement sheet 406 also includes a fuel ingress opening 414 which is aligned with the fuel ingress openings 201, 412 in the other layers in the assembly.

One or more alignment gaskets 408, 409 are provided between the anode and cathode gasket layers 404, 432. The alignment gaskets 408, 409 are provided with an adhesive or bonding material on both sides. Thus, they are able to allow the attachment of the two gaskets 404, 432, together. During the assembly process, the positioning of the alignment gasket layers 408, 409 helps to ensure alignment of the component of the fuel cell assembly 400.

In this embodiment, two alignment gaskets 408, 409 are positioned so that one will be aligned with the fuel ingress area of the graphite plate 200 or fuel cell stack 402, and the other will be aligned with the fuel egress area of the graphite plate 200 or fuel cell stack 402. The alignment gasket layer 408 can therefore provide additional sealing against leakage from the flow field. However, it is possible for the alignment gaskets 408, 409 to have different locations.

The alignment gasket layer 408 has at least a cut-out 416 to accommodate the fuel ingress and the other alignment gasket layer 409 has a cut-out 417 to accommodate the fuel egress. Additional apertures 418, 419 may be provided in the alignment gasket layer 408, 409 respectively, to align with attachment apertures 208 provided in the bipolar plates 200a, 200b, and the attachment apertures 420, 440 in the gasket layers 404, 432, for receiving securing means (e.g., screws, bolts, rivets, rods, etc). These aligned attachment apertures are provided for securing the plates together to assemble the fuel cell(s), or to secure the fuel stack to the housing 101, or both.

The membrane electrode assembly 422 is provided between the bipolar plates 200a, 200b, generally in a central part of the bipolar plates 200a, 200b. In the depicted embodiment, the membrane electrode assembly 422 is provided between the anode gasket 404 and the cathode gasket 432. The anode and cathode gasket layers 404, 432 thus have an accordingly positioned and dimensioned openings 424, 434, to allow communication between the flow fields 206 and the membrane electrode assembly 422, and the membrane electrode assembly 422 and the air channels (not shown).

In this example, the membrane electrode assembly 422 includes a flange portion 428 which is at least partially located outside of the central opening or cut-out 424 on the gasket layer 404. An electrode seal 426 secures and seals membrane electrode assembly 422, or more particularly the flange portion 428, onto the anode gasket layer 404. In other embodiments, the electrode seal 426 may instead secure and seal the membrane electrode assembly 422 onto the cathode gasket layer 432. The electrode seal 426 also provides a central opening 430 to allow the communication of the membrane electrode assembly 422 with the cathode side of the adjacent plate 200.

As an example only, the following materials and dimensions are provided. The gasket layer 404 itself may be a polytetrafluoroethylene (PTFE) material, or another material which is hydrophobic or not permeable to water, and which has chemical resistance. It may be a single sided sticky PTFE gasket of, e.g., approximately 130 micrometres (μm) in thickness. As the PTFE material may not provide sufficient rigidity, there are also provided reinforcing sheets, which are made of a stainless steel material and have about 100 μm in thickness. The alignment gasket layers 408, 409 may be a double-sided sticky polyimide tape, i.e., with adhesive or a bonding material applied on both sides. This alignment gasket layer 408 may be approximately 40 μm in thickness. The alignment gasket layers 408, 409 do not need to be co-extensive with the plate 200. The electrode seal 426 preferably only has adhesive on the side which faces the bipolar plate 200, to secure the electrode 422 in the bipolar plate assembly 400.

The above described modified housing and stack design helps to improve the thermal stack management and to reduce the stack parasitic power consumption.

One way of constructing the arrangement described above is to provide pre-formed implements (composed of horizontal plates with sharp blades perpendicular to the main plate) to cut the gaskets and the gas diffusion (i.e., membrane) electrode. This approach ensures that the dimension of the gaskets and electrode are identical between each cell in the stack. Regarding gas sealing, it has been addressed using the following approaches. On the anode and cathode side, a single-side sticky PTFE gasket (130 μm thick) was added onto the plate to provide gas sealing as described above, using the pre-cuts and the hot-press to cut them. A stainless steel sheet (100 μm thick) is added underneath the PTFE sheet to serve as the reinforcement sheet, to add rigidity to the gasket over any flow field area or path with a width of 2 mm (above each of the hydrogen inlet and exhaust). Furthermore, double-sided polyimide tape (40 μm thick) is added above the stainless steel sheet to provide additional sealing. Finally, the membrane electrode assembly (MEA) was installed in the bipolar plate on the anode side, using polyimide tape to seal the edges of the membrane.

The invention, for instance, can be used to provide a 5-cell stack. It will be appreciated that more or fewer than six graphite plates may be used to provide a stack of a different number of fuel cells. This invention is not limited to 5-cell stacks.

Adjacent a first outer plate 106 and current collector 105, six graphite plates are assembled on top of each other to constitute a 5-cell stack. The first outer plate 106 will be located on the bottom of the stack during the assembly process. A plurality of, in this case four, central screws, and the plexiglass cooling element are used to align the plates. Voltage sensors may be inserted on the side of each graphite plate for voltage collection. Referring to FIG. 1 and FIG. 3, these bolts or screws will be provided through the openings 130 (not shown) provided on the outer plates 106, and the through apertures 208 provided in the graphite plates.

A second outer plate 104, which will be located on the top of the cell, is aligned with the plates to complete the assembly. The cooling element 112 is then screwed into the top outer plate 104 through the openings 130 (shown in FIG. 1). Following assembly, between 0.5 and 3 Nm is applied to each bolt or screw through the aligned openings 130, 208 using an adjustable torque wrench. Further attachment openings 132, preferably evenly along the top and bottom outer plates, to surround the graphite plates and the bipolar copper plate, may be provided. These are adapted to accept screws, bolts, or other attachments means, to help to ensure uniform compressing, whereas the screws inside the stack, provided through the aligned openings 130, 208 also provide alignment and compression.

The manufacturing and assembly approach, using a computer controlled milling machine, water-jet cutting, laser cutting, and pre-cuts for delicate pieces, represent significant innovations for a research stack, greatly reducing imprecisions due to more rudimentary methods such as hand drilling, and significantly enhances the rapid prototyping time. The entire stack, including graphite plates, can be machined in less than 12 hours.

Specifically, the laser cutting approach to the cooling element manufacturing represents a significant innovation in engineering: it simplifies the manufacturing process directly from design-to-prototype and easy scale-up. Using a laser cutter greatly improves the accuracy of the design, ensuring that minimum amounts of air escapes from the gaps between the different parts of the cooling blocks. In addition, as described above with reference to FIG. 1, the cylindrical holes in the cooling element provide additional room for movements of the stack during expansion/compression after assembly.

Regarding the pre-cuts approach, this semi-automated approach is a significant innovation as these custom-made reliable tools simply the cutting and machining of the gaskets and electrodes, provide additional reliability before an automated approach can be introduced, and narrow the gap in performances between research and industrial approaches.

Finally, the materials introduced for gas sealing (PTFE and polyimide tape) provides represents a new application for these versatile, extremely low-cost, and already fully commercialized materials and is a significant, and innovative cost-reduction.

Electrochemical Diagnoses

Electrochemical impedance spectroscopy (EIS) of each cell within the stack can be performed to investigate the stack performance, with a frequency range from 10 kHz to 0.1 Hz, and an amplitude of 10% of the DC signal. From the EIS performed on the 5-cell stack, the difference in performance between each cell is limited, with cell 2 (the second cell from the bottom) possessing the highest resistance, and cell 3 (the third cell from the bottom) the lowest resistance. Other features observed include a reduction of resistance from the charge transfer region (<200 mA cm⁻²), stabilization in the ohmic region (400 mA cm⁻²-600 mA cm⁻²), and an increase in the mass transport region (800 mA cm⁻²). From the first analysis, the state-of-health of each cell is acceptable without abnormally higher or lower resistances across the stack.

Modifications to the bipolar plate graphite flow fields will improve the thermal stack management and reduce parasitic power consumption. Primarily, the channel-to-land ratios and channel height of the cathode channels are varied to increase the amount of air flowing within the stack for a set air blower flow rate, increasing the channel width from the standard sizing of about 1 mm to about 1.2 mm, or 1.4 mm, or higher. Similarly, the channel depth may be increased. The increase in the channel dimensions will need to be carefully considered to avoid damaging the integrity of the graphite plates. Modifying the air channel structure to increase the depth, width, or both, of the air channel cross section, enables more air to be forced through the gas diffusion layer, while retaining more water within the stack to keep the water retention in the membrane. This approach will also reduce the ohmic resistance, as more water will remain within the membrane and catalyst instead of being removed by the high cathodic gas stream (i.e., air stream).

Also, the optimum distance between the stack and the cooling element can be determined via a modification of the outer plate and cooling element configuration to reduce air flow decrease before the air flow reaches the stack. For instance, the separation between the cooling element to the edge of the fuel cell stack 102 may be between 0.2 centimetres to 2 centimetres. This optimization will increase the amount of air flowing through the stack for a set air blower power, leading to a reduction of the air blowers' power consumption to hold the stack at a set temperature. The stack optimum operating temperature, from an electrochemical perspective, can be determined to choose air blowers with the least amount of power consumption to operate the stack at this temperature.

The improvement in the air flow, combined with the modification of the flow field, will significantly reduce the stack parasitic power consumption. For example, the hydrogen flow fields 206 may be provided with a serpentine (see FIG. 11) or double serpentine configuration (see FIG. 10) to improve water removal and management, and help reduce the pressure drop. The double serpentine flow field 1000 or serpentine flow field 1100 respectively shown in FIGS. 10 and 11 each include a single inlet pathway 1002, 1102 and a single outlet pathway 1004, 1104, rather than the three parallel inlet pathways and outlet pathways shown in FIG. 3. However multiple inlet and outlet pathways may still be provided. In the flow fields 1000, 1100 between the inlet and the outlet, there is at least one winding or serpentine flow channel 1006, 1106. That is, the flow channel 1006, 1106 has a longer length than the length of the distance between the inlet pathway 1002, 1102 and the outlet pathway 1004, 1104. The longer length of the flow channel 1006, 1106 provides more space for the biproduct of the chemical reaction, i.e., H₂O in the case of hydrogen fuel cells, to be moved by the fuel flow. This reduces the likelihood of the water building up in the fuel flow fields 1000, 1100 and creating blockage for the fuel flow.

Aside from modifying the design of the stack, the stack optimum operating temperature from an electrochemical perspective will be determined to choose air blowers with the least amount of power consumption to operate the stack at this temperature. To quantify the improvement, for a five-cells stack, five thermocouples can be used to monitor the temperature at the centre of each cell, and the proportional integral derivative (PID) controller will control the average temperature of the stack, while the correlation between the air blower power and the electrochemical performances will be elucidated. In parallel to these efforts, the new membrane, flow-field, and cooling strategy can be operated in a stack provided with more cells in accordance with the invention, e.g., a 20-cell stack, to determine its operations and evaluate the stack power characteristics.

The performance or economy of the fuel stack may be further improved by using novel catalyst. In prior art fuel stacks, precious metals (currently 60% platinum/carbon, 0.5 mg cm⁻²) are required for the catalysts. There are known alternatives which do not include precious metals, for example, platinum group metal-free (PGM-free) catalysts. However, the poor durability and stability of these catalysts impede the practicality of their substitution for platinum-based catalysts.

Herein disclosed is a novel non-precious metal catalyst. In one embodiment the catalyst is a polyaniline (PANI)-derived catalyst with dual active centre. The catalyst may be synthesised by using FeCe Prussian blue analogues (PBAs) as precursor to eliminate hydrogen peroxide (H₂O₂), thereby improving the durability and the stability of the catalyst. The catalyst further comprises cerium (Ce), the presence of which is found to decrease the yield of H₂O₂.

It has also been found that Ce performed as pore formation regent, increasing the utilization of the electrochemical surface area of the electrode. For example, one embodiment of the catalyst is PANI-FeCe—N—C, pyrolyzed at 900 degrees Celsius (PANI-FeCe—N—C-900). In an acidic electrolyte, the half-wave potential (Eva) of PANI-FeCe—N—C-900 positively shifted by 17 millivolts (mV), compared with the Ce free version, PANI-Fe—N—C-900.

The durability of the catalyst is also found to be improved. In one experiment, after 30,000 cycles of accelerated degradation tests (ADT), the E_{1/2} of PANI-FeCe—N—C-900 negatively shifted by 29 mV, which is significantly lower than that of traditional Pt/C catalysts (ΔE1/2=133 mV after 10,000 ADT). The much-improved durability may be attributed to Ce moieties acting as free radical scavenger.

In an alkaline electrolyte, PANI-FeCe—N—C-900 presented a decent oxygen reduction reaction performance with a high E_{1/2} (0.98 V), which exceeds than that of the traditional platinum-carbon (Pt/C) catalyst.

Example methods of preparing the catalyst are provided below.

Commercially available chemicals can be used. For instance, iron chloride (FeCl₃·6H₂O, >99%) and Cerium chloride (CeCl₃·7H₂O, >99%) were purchased from Sigm1Aldrich. Ammonium peroxydisulfate ((NH₄)2S₂O₈, >99%) and 2-propanol (>99.9%) were purchased from Chem-supply Ltd. Hydrochloric acid (HCl, 32%), sulfuric acid (H₂SO₄, 98.0%), nitrite acid (HNO₃, 70%) and hydrogen peroxide (H₂O₂, 30%) were purchased from RCI Labscan Limited. Aniline (>99.5%) was purchased from Scharlau S. L. Potassium ferricyanate (K₃Fe(CN)₆, >99.5%) was purchased from Ajax Finechem Pty Ltd. Pt/C (20 wt. % on carbon black) was purchased from Johnson Matthey. Nafion (5 wt. %, D520) was purchased from DuPont®. To provide the carbon, Ketjen black EC-600JD was purchased from Akzo Nobel Polymer Chemicals B. V.

Catalyst Synthesis.

Preparation of the Sulfonated Carbon Black.

The carbon provides support for the catalyst. In some embodiments, —SO₃ functional groups are grafted onto the carbon to create sulfonated carbon, to increase the interaction of aniline with the carbon.

In one experiment, a commercial carbon, Ketjen black EC-600JD, with a high Brunauer—Emmett—Teller (BET) surface area (1270 m² g⁻¹), was used as carbon support. SO₃ functional groups were then grafted onto the carbon black. Briefly, approximately 1 gram (g) of carbon was treated with 100 mL of mixed acid (V_{HNO3}: V_{H2SO4}=1:1), under the protection of N₂ with high purity at 80° C. for 48 hours. The black tar was vigorously stirred during the sulfonation. As the sulfonation terminated, the carbon black was filtered out and washed with distilled water to remove the residual acid. The sulfonated carbon black was then vacuum-dried using a rotary evaporator.

Preparation of Polyaniline-Prussian Blue Analogue Compounds (PANI-PBAs)

The polyaniline-Prussian blue analogue compounds (PANI-PBAs) provide precursors for the PANI-derived catalysts.

In one experiment, about 0.2 g of sulfonated carbon and 2.4 g of K₃Fe(CN)₆ are mixed with about 70 mL of hydrochloride acid with a concentration of 1M. The mixture was dispersed in ice bath by a digital sonifer. After ultrasonication, 2 mL of aniline was dropwise added into the mixture while it was being stirred. The mixture continued to be stirred in an ice bath for another hour. A solution of about 2.0 g of (NH₄)₂S₂O₈ and 3.65 mmol of MCl₃ (M=Fe, Ce) into 30 mL of distilled water was then added into the flask. The addition was made in a dropwise fashion. The duration of the dropping process lasted about 6 hours, during which the mixture was stirred in the ice bath. The molar amount of the metal chloride is almost half of K₃Fe(CN)₆ to ensure that all trivalent metal ions can be converted into PBAs.

In the experiment, the as-received Prussian blue analogue compounds (PBAs) are FeₓCe PBAs. The subscript x denotes the molar ratio of Fe to Ce in the PBAs. x is generally in the range of 0 to 1 (excluding 0). For x=1, which corresponds to PANI-Fe PB, the amount of FeCl₃·6H₂O is 0.9868 g; for PANI-Fe₂Ce PBAs, the addition of FeCl₃·6H₂O and CeCl₃·7H₂O are 0.4933 and 0.68 g respectively; for PANI-FeCe PBAs, the addition of CeCl₃·7H₂O is 1.36 g.

The mixture was stirred for another 12 hours at room temperature. The as-received raw precursors were then vacuum filtered and vacuum dried at 80° C.

Preparation of PANI-derived Catalysts

The PANI-derived catalysts can be prepared by pyrolysis, i.e., by thermally decomposing the prepared raw precursors. The pyrolysis may be followed by leaching to remove the larger metal particles. A further pyrolysis process may be performed to enhance the effectiveness of the catalyst.

In one experiment, initially, the raw precursor was grinded and then transferred into a tube furnace. The ceramic tube was purged with N₂ gas (>99.99%). The pyrolysis was then performed by ramping the temperature from room temperature to the target temperature at a ramping rate of 5° C. per minute, and cooled down to the room temperature at a rate of −5° C. per minute. The compound was then pyrolysed at the target temperature for 3 hours to achieve a full carbonization. The targeting temperature may be set between 700 and 1000 degrees Celsius.

The catalysts obtained after the first pyrolysis were leached in 0.5 M H₂SO₄ at 80° C. for 12 hours to remove large metal particles. After acid washing, the catalyst was vacuum filtered out and washed with distilled water to remove trace amount of acid. The catalyst was then vacuum dried at 80° C.

In the experiment, the second pyrolysis was identical to that of the first pyrolysis. The as received catalysts, i.e., the result from the second pyrolysis, can be denoted as PANI-FeₓCe—N—C. The “x” corresponds to the molar ratio of Fe to Ce in FeCe PBAs, and is determined by the final product of FeCe[(CN)6].

Electrochemical Characterizations

The below describes experimentation to determine the electrochemical characterizations of various catalysts, including the novel catalyst mentioned above. The experimentation was performed on a CHI Electrochemical Station (Model 900B) in conjunction with a rotating ring disk electrode (RRDE, RRDE-3A, ALS Co., Ltd). All of the electrochemical characterizations were conducted in a three-electrode electrochemical cell at room temperature (25° C.). A carbon plate (of 2.0 cm×1.0 cm in area) and a saturated calomel electrode (SCE) electrode were used as the counter and reference electrode, respectively. Before electrochemical characterizations, the SCE was calibrated in an H₂-saturated 0.5 M H₂SO₄ aqueous solution, by linear scanning voltammetry (LSV) with a scan rate of 1 mV·s⁻¹. The calibrated ΔE was —0.265 V (vs. SCE). The electrochemical potentials in this work were referenced to reversible hydrogen electrode (RHE). The electrolytes used for ORR performance characterization were 0.5 M H₂SO₄ and 0.1 M KOH. The electrolytes were purged with N₂ or O₂ with high purity for at least 30 minutes before the experiment (for safety restriction, 0.5 M H₂SO₄ instead of 0.1 M HClO₄ was used for ORR performance evaluation).

The catalyst ink was prepared as follows: 2.5 mg of the analysed catalyst were dispersed in a mixture of 7.5 μL Nafion (5.0 wt. %, DuPont Corp.) and 0.5 mL isopropanol. The mixture was sonicated in ice bath for 2 hours to yield a homogeneous catalyst ink. The catalyst ink was then spin coated onto the glassy carbon disk (φ4 mm) at 300 rpm, which was then left to dry in air at room temperature. For PGM-free catalysts, the procedure was repeated to yield a catalyst loading of 0.6 mg cm⁻². For commercial Pt/C (20 wt. %), the loading of was set to be 60 μg_{Pt} cm⁻².

Before experiments, the Pt ring was cleaned by cycling potential in 0.5 M H₂SO₄ from 0 to 1.4 V at a scan rate of 50 mV s⁻¹ for 20 cycles.

The ORR performances were recorded by linear sweep voltammograms (LSVs) with an electrode rotation speed of 900 rpm in O₂-saturated electrolyte, the potential on disk electrode was swept from 1.0 to 0.2 V at a scan rate of 10 mV·s⁻¹. The background capacitive currents were recorded in N₂-saturated electrolyte under the identical testing conditions after the ORR test. Then final ORR current was calibrated by the subtracting the background capacitive current.

During the rotating ring disk electrode (RRDE) experiments, the ring potential was set to 1.2 V. The four-electron selectivity of catalysts was evaluated according to the H₂O₂ yield (% H₂O₂), calculated from the following equations:

$$\% {H}_{2} {O}_{2} = \frac{2 {I}_{r}}{N \vert {I}_{d} \vert + {I}_{r}} \times 100 \% \qquad ( 1 )$$

$$n = 4 - 2 \times \frac{\% {H}_{2} {O}_{2}}{100} \qquad ( 2 )$$

Cyclic voltammetry (CV) curves were performed in O₂- and N₂-saturated electrolytes to gain surface information of the catalysts during the ORR. The catalyst layer was subjected to potential cycling from 0.05 to 1.2 V (vs. RHE) at 50 mV s⁻¹ until steady voltammograms were gained.

Catalyst stability and methanol tolerance have been evaluated by chronoamperometry in O₂-saturated electrolyte. Catalyst stability was evaluated at 0.5 V for 9,000 s with a rotation speed of 200 rpm during the test. The methanol tolerance has been evaluated in O₂-saturated electrolyte containing 1 M methanol for 1,000 s.

After the ORR test, electrochemical surface area (ECSA) was recorded to investigate the utilization of catalyst surface areas. ECSA of the PGM-free catalysts can be estimated and compared with their C_{dl} values since there is a linear correlation between C_{dl} and ECSA (C_{dl}˜υ×ECSA). The C_{dl} was calculated from double-layer charging curves in a non-faradic potential range. The double layer capacitance C_{dl} (F cm⁻²) can be related to the current density through the following equation:

$${C}_{dl} = \frac{i}{v}$$

where i is the current density (mA cm⁻²), and ν is the scan rate (mV s⁻¹).

Durability Test

The durability of the catalysts were evaluated via accelerated durability tests (ADTs). The ADTs were performed in O₂-saturated electrolytes. The electrodes were cycled at a scan rate of 0.05 V s⁻¹ from 0.6 to 1.0 V. The ORR performances of the catalysts prior and post to the ADTs were recorded.

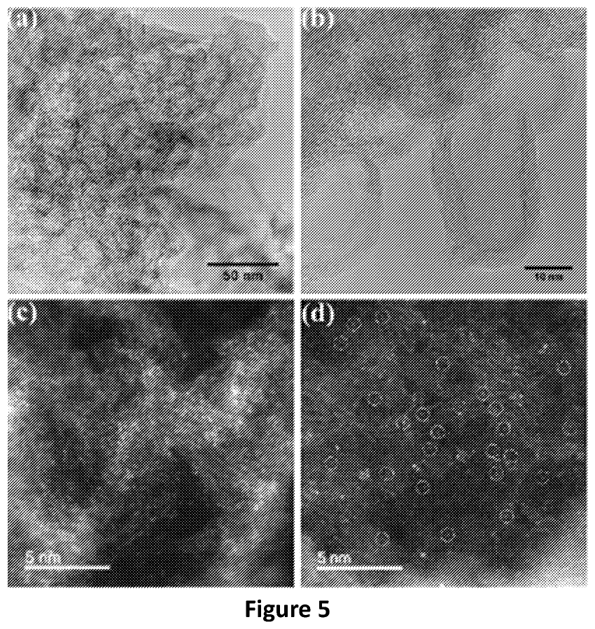

The detailed morphology and elemental distribution of the prepared catalysts are shown in FIG. 5. As shown in FIG. 5, panel (a), the prepared PANI-Fe—N—C-900 is mesoporous, with no big particles presented in the catalysts. As shown in FIG. 5, panel (b), carbon nano-shells formed in the PANI-FeCe—N—C-900. A possible formation mechanism is that under high temperature, graphite formed around the metal particles. When the metal particles leached away, a hollow carbon nanoshell then formed. Aberration-corrected High-Angle Annular Dark Field Scanning transmission electron microscopy (HAADF-STEM) tomography was employed to investigate the detailed structure of the catalysts. As shown in FIG. 5, panel (c) and FIG. 5, panel (d), Fe, Ce, or both are atomically dispersed in the carbon matrix, indicating that a single atom catalyst can be prepared in the present strategy. The tomography investigating the elemental distribution of PANI-FeCe—N—C-900 showed that the elements Fe, Ce, N and C formed a uniformed distribution in the PANI-FeCe—N—C-900 catalyst.

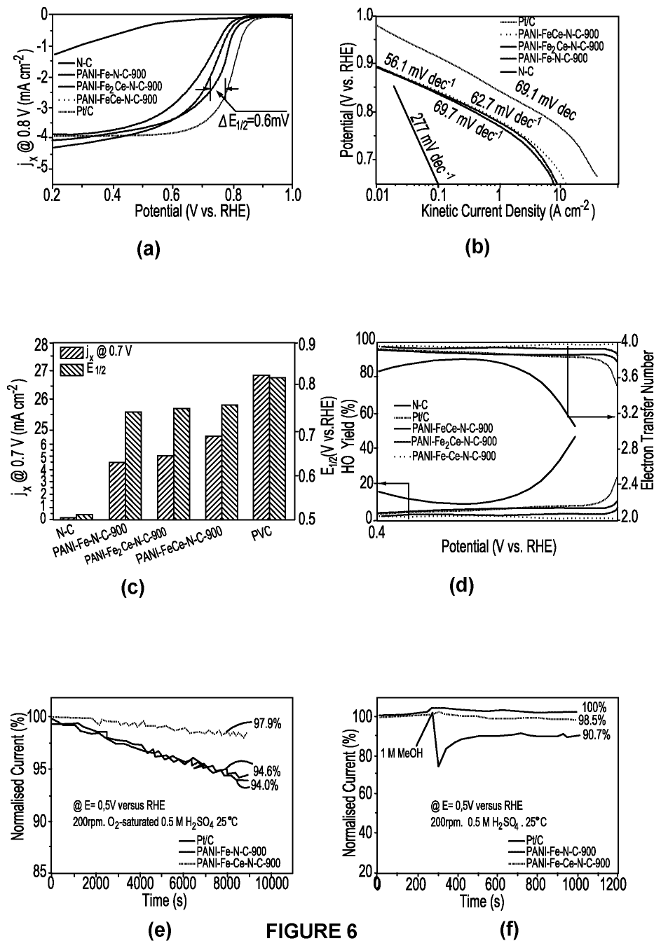

The ORR performance of the catalysts have been evaluated by the Rotatory Ring Disk Electrode (RRDE) method. Pt/C with a high loading of 60 μg_{Pt} cm⁻² was employed as benchmark. N—C was prepared by pyrolysing PANI-coated sulfonated EC-600 at 900° C. in N₂. As shown in FIG. 6, panel (a), the ORR performance of PGM-free catalysts increased with incorporation of metal in the catalysts. Notably, with an increase of cerium in the catalysts, the ORR activity has increased.

Further referring to FIG. 6, panel (a), the best ORR performance was achieved by PANI-FeCe—N—C-900, the difference in half wave potential (E_{1/2}) between PANI-FeCe—N—C-900 and Pt/C is ca. 60 mV.

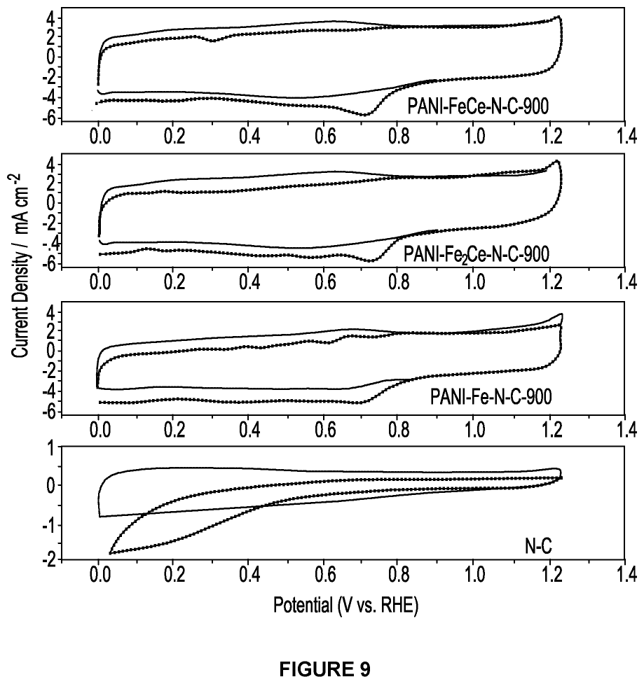

The surface transitions during ORR were investigated using the Cyclic voltammetry (CV) method (see FIG. 9). As shown in FIG. 9, the voltammograms of PANI-derived catalysts present broad capacitive currents in N2-saturated 0.5 M H₂SO₄. A pair of weak redox peak appeared at ca. 0.6 V, while disappeared in N—C. The redox peak may be ascribed to: (i) one-electron reduction/oxidation of the surface quinone-hydroquinone groups and (ii) Fe₃+/Fe₂+ reduction/oxidation. Comparing the redox behaviour in both PANI-M-N—C catalysts and N—C, the redox peak in PANI-M-N—C is more likely to be ascribed to Fe₃+/Fe₂+ reduction/oxidation.

To gain insight into the impact of composition on ORR activity, a Tafel plot of potential versus kinetic current density was obtained. The kinetic currents in were deconvoluted by Kouteck-Levich equation:

j⁻¹=jₖ⁻¹+jₗᵢₘ⁻¹ (3)

To eliminate the uncertainty in jₗᵢₘ, the values of jₗᵢₘ are taken at 0.2 V.

FIG. 6, panel (b) shows the Tafel plot of Pt/C, imposed over that of the PGM-free catalysts. The large discrepancy on one hand is caused by the high loading of Pt/C. The Tafel slope of N—C is 277 mV/dec, indicating that the over potential of ORR in N—C is large. With an incorporation of Fe and Ce into the N—C matrix, the Tafel slope of PANI-derived catalysts decreased from 69.7 to 56.1 mV/dec. Compared with Pt/C (69.1 mV/dec), PANI-FeCe—N—C is more energy favorable to ORR, with a slope of 56.1 mV/dec. That is, using PANI-FeCe—N—C, less energy will be consumed for the ORR process, hence it will be more likely to proceed.

In a high over potential range, the kinetic current densities of PANI-derived catalysts diverged from each other. With an increase of Ce in the catalysts, the kinetic current density increased. FIG. 6, panel (c) shows the E_{1/2} and kinetic current densities (@0.7 V) of different catalysts. A clear tendency of activity increasing, corresponding to an increase in the Ce, can be seen.

A comparison of the ORR performance of PANI-FeCe—N—C-900 in an acidic medium with that of nonprecious metal catalysts (NPMCs) known in the literature is shown in Table 1 below.

TABLE 1

| | Catalyst | Half-wave | |
|---|---|---|---|
| | loading | potential | Current density @ |
| Catalysts | (mg cm⁻²) | (V vs. RHE) | 0.7 V (mA cm⁻²) |
| CoP-CMP800 | 0.6 | 0.64 | 1.20 |
| NDCN-22 | 0.6 | 0.57 | <0.5 |
| PMF-800 | 1.2 | 0.62 | 1.35 |
| Fe—N/MPC2 | 0.6 | 0.72 | 1.75 |
| WC@C/N/C1850 | 0.4 | 0.50 | 0.25 |
| CoN-CNS | 0.4 | 0.64 | 0.01 |
| Fe₃C@C-900 | 0.6 | 0.68 | 1.80 |
| Py-FCC/C-50 | 1.3 | 0.70 | 2.60 |
| Fe—N—C-800 | unknown | 0.76 | 0.50 |
| C-PANI-MIL-2 | 0.4 | 0.67 | 2.05 |
| PANI-FeCe—N—C- | 0.6 | 0.76 | 2.81 |
| 900 | | | |

PANI-FeCe—N—C-900 has a similar E_{1/2} with other catalysts, generally ranged from 0.7 to 0.8 V. Its current density (measured at 0.7 V) is also the highest. The results indicate that the performance of PANI-FeCe—N—C-900 is promising to be applied in proton exchange membrane fuel cell (PEMFC_.

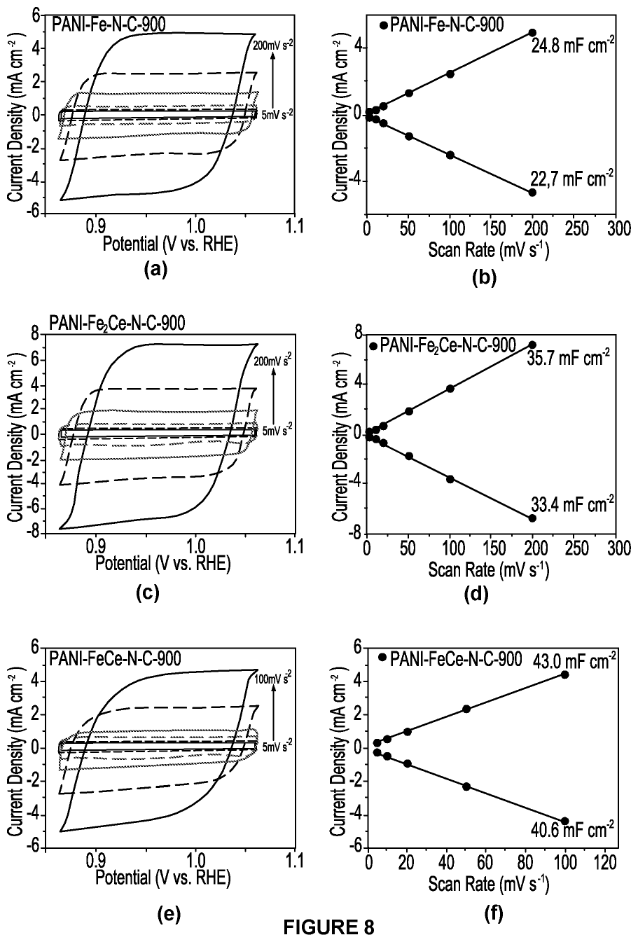

Electrochemical surface areas (ECSAs) of the prepared catalysts have been quantified via an estimation of double capacitance (C_{dl}) values near open circuit potential. As shown in FIG. 8, the C_{dl} is increased, when the Ce amount in the PGM-free catalysts is increased. The C_{dl} value of PANI-FeCe—N—C-900 is 43.0 mF cm⁻² (anodic fraction), which is 1.73 times higher than PANI-Fe—N—C-900. As the ECSA is the available surface area for electrocatalysis, an increased ECSA in PANI-FeCe—N—C-900 predicts its higher ORR activity.

During the ORR process, H₂O₂ is an important product that holds strong impact on the durability of PGM-free catalysts. The N-doped carbon surface can be attacked, i.e., corroded or caused to decompose, by the presence of H₂O₂. Fe at active sites of catalysts is attacked by hydroxyl free radicals decomposed from H₂O₂. The leaching out of Fe causes an increase in activity loss. The presence of free radical species will also attack the ionomers and N-doped carbon surface. The Fe species leached from N-doped carbon matrix will propagate the Fenton reactions, further worsening the situation of the PGM-free catalysts.

Therefore, in some embodiments, to eliminate the formation of free radical species during ORR presence, the Fe is replaced with other transition metals such as manganese or cobalt, which have less activity towards Fenton reactions. The trade-off is that the activity of the PGM-free catalysts with the replaced Fe may suffer from a mild drop in ORR activity. It has previously been validated that MnN₄ sites can catalyze the ORR following a 4 e− pathway. The results revealed that the MnN₄ sites could catalyze ORR with a half-wave potential only 60 mV lower than that of Pt (111) sites and 80 mV lower than that of the FeN₄ sites.

In some embodiments, instead of replacing the Fe with other transition metals, a free radical scavenger (FRS) is incorporated into the catalysts, forming PGM-free catalysts with dual active centres for both ORR and radical scavenging.

In the present invention, cerium (Ce) has been incorporated into PANI-Fe—N—C catalysts with the aim of in-situ scavenging H₂O₂. The cerium atoms may also act as pore forming agents. The H₂O₂ yield was monitored by ring current during the ORR process.

As shown in FIG. 6, panel (b), N—C presents the highest H2O2 H₂O₂ yield, of 44.0%, at 0.65 V. However, the low ORR current for N—C makes it less favourable to be applied in electrochemical synthesis of H₂O₂.

For PANI-Fe—N—C, the H₂O₂ yield is 9.1%, at a fuel cell operating potential of 0.65 V. With an addition of Ce into the catalysts, H₂O₂ yield can be gradually reduced. Compared with other known PGM-free catalysts, PANI-FeCe—N—C-900 presents the lowest H₂O₂ yield (4.1%, at 0.65 V). The decrease in the H₂O₂ can be contributed to the following mechanism:

Ce⁴⁺+H₂O₂ →Ce³⁺+HOO·+H⁺ (4)

Ce⁴⁺+HOO·→Ce³⁺+O₂+H⁺ (5)

Ce³⁺+HO·+H⁺+O₂→Ce⁴⁺+H₂O (6)

The above equations show that Ce can be completely regenerated at the end of the scavenging cycle.

The catalyst stability of has been evaluated by chronoamperometry at 0.5V. As shown in FIG. 6, panel (e), PANI-FeCe—N—C-900 presents a high stability over PANI-Fe—N—C-900 and Pt/C. At the end of the stability test, the current of PANI-FeCe—N—C-900 retained 97.9%. Whist PANI-Fe—N—C-900 and Pt/C presented a similar decreasing mode, the current retained ca. 94.0% at the end of the stability test.

Methanol can be used as fuel for PEMFCs. However, it has previously been found that the crossover of methanol from the anode to the cathode caused a significant potential loss as high as 150 mV. Hence, methanol tolerance is an important feature of the ORR catalysts. The methanol tolerance of the catalysts was evaluated by chronoamperometry at 0.5V and adding pure methanol into the O₂-saturated electrolyte, the concentration of methanol in the electrolyte is set to be 1 M.

As shown in FIG. 6, panel (f), PGM-free catalysts presented a higher methanol tolerance than Pt/C. After the addition of methanol in the electrolyte, the ORR current of Pt/C dropped instantly, and then slowly recovered to 90.7% at the end of the test. This is because Pt/C is not only active towards ORR, but also active towards methanol oxidation reaction (MOR). The intermediate species from MOR will adsorb onto Pt, occupying the active sites. For PANI-derived catalysts, because of its low activity towards MOR, the selectivity of ORR is not significantly affected. The reaction speed of the ORR is not impacted or significantly impacted as MOR does not cause any or significant interference to the ORR.

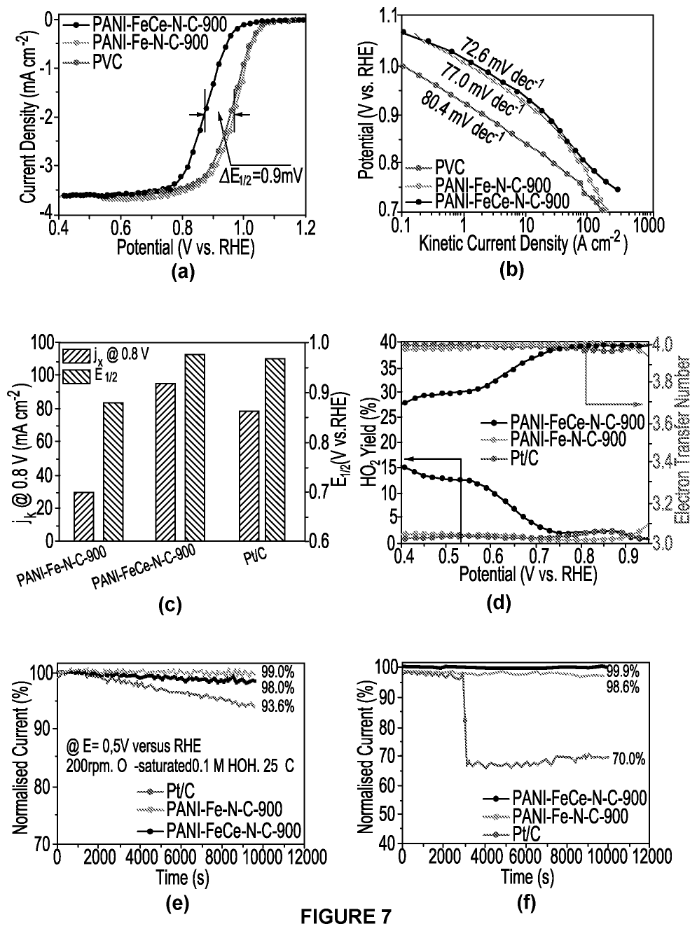

The ORR performance of PANI-derived catalysts have been also evaluated in 0.1 M KOH. As shown in FIG. 7, panel (a), PANI-FeCe—N—C-900 presents the highest ORR performance. The ORR performance of PANI-FeCe—N—C-900 even exceeded that of Pt/C with a high Pt loading. With the incorporation of Ce in the PGM-free catalyst, the E_{1/2} positively shifted by 97 mV. As shown in FIG. 7, panel (b), the Tafel slope of PANI-FeCe—N—C-900 is 72.6 mV/dec, which is slightly lower than that of Pt/C. The addition of Ce into PANI-Fe—N—C is shown to reduce the energy barrier of ORR. The kinetic current density at 0.8 V) and the E_{1/2} are summarized in FIG. 7, panel (c). From FIG. 7, panel (c), it can be seen that the kinetic current density, jₖ (at an operating potential of 0.8 V) of PANI-FeCe—N—C-900 is 95.5 mA cm⁻², which is approximately 3.2 fold higher than that of PANI-Fe—N—C-900. The enhanced ORR activity maybe contributed to 1) the high ECSA of PANI-FeCe—N—C-900 and 2) synergetic effect between Fe and Ce. In Table S2 below, the ORR performance of PANI-FeCe—N—C-900 in alkaline medium has been compared with other PGM-free catalysts reported in the literatures. From Table S2, PANI-FeCe—N—C-900 presents the highest E_{1/2} (0.98 V vs. RHE), which is 10 mV higher than Pt/C with a high loading and more positive than the reported values of PGM-free catalysts.

Intriguingly, the H202 yield in PANI-FeCe—N—C-900 is significantly higher than PANI-Fe—N—C-900 and Pt/C below the potential of 0.75 V, as shown in FIG. 7, panel (d). It was expected the H₂O₂ yield should keep low in alkaline electrolyte. Surprisingly, the H₂O₂ yield increased with decreasing in the potential.

TABLE S1
ORR performance of NPMCs tested in alkaline medium.

| | Catalyst | Half-wave | |
|---|---|---|---|
| | loading | potential | Current density @ |
| Catalysts | (mg cm⁻²) | (V vs. RHE) | 0.7 V (mA cm⁻²) |
| CoP-CMP800 | 0.6 | 0.64 | 1.20 |
| NDCN-22 | 0.6 | 0.57 | <0.5 |
| PMF-800 | 1.2 | 0.62 | 1.35 |
| Fe—N/MPC2 | 0.6 | 0.72 | 1.75 |
| WC@C/N/C1850 | 0.4 | 0.50 | 0.25 |
| CoN-CNS | 0.4 | 0.64 | 0.01 |
| Fe3C@C-900 | 0.6 | 0.68 | 1.80 |
| Py-FCC/C-50 | 1.3 | 0.70 | 2.60 |
| Fe—N—C-800 | unknown | 0.76 | 0.50 |
| C-PANI-MIL-2 | 0.4 | 0.67 | 2.05 |
| N/Fe-CG | — | 0.86 | 3.70 |
| Pt/C (20 wt. %) | 0.3 | 0.97 | 3.57 |
| PANI-FeCe—N—C- | 0.6 | 0.98 | 3.70 |
| 900 | | | |

Such phenomenon may be ascribed to the different role of Ce species in alkaline electrolyte. In alkaline electrolyte, HO₂⁻ is the stable product from 2 e⁻ process. For example, it was shown previously that by adding CeO₂ into multi-walled carbon nanotube, the CeO₂ can contribute to the production of H02″ in the alkaline electrolyte. Referring back to Equation (5) above, Ce⁴⁺ can effectively convert H₂O₂ into HOO·. Due to the presence of OH⁻ in the electrolyte, the reaction in Equation (5) has been greatly boosted. Because of the deprivation of protons in the alkaline condition, Ce³⁺ cannot be converted into Ce⁴⁺ in the reaction expressed by Equation (6).

Due to the resulting reduction in the amount of Ce⁴⁺ in the PANI-FeCe—N—C-900, HOO· cannot be effectively converted into O₂. Consequently, this yields a higher production of H02″ in PANI-FeCe—N—C-900.

The stability of the prepared catalysts has been also evaluated in 0.1 M KOH solution. As shown in FIG. 7, panel (e), both of PANI-FeCe—N—C-900 and PANI-Fe—N—C-900 delivered a significantly higher stability than Pt/C. The stability of PANI-FeCe—N—C-900 is 1% lower than that of PANI-Fe—N—C-900, which may be caused by the higher H02″ yield of PANI-FeCe—N—C-900 at 0.5 V. The methanol tolerance has been evaluated in 0.1 M KOH containing 1 M methanol. As shown in FIG. 7, panel (f), the ORR current of Pt/C dropped instantly upon the addition of methanol, and the current was lowered to 70% of the peak current value, at the end of the test. The ORR current, for PANI-FeCe—N—C-900 and PANI-Fe—N—C-900, on the other hand, kept nearly unchanged. The high methanol tolerance of PANI-FeCe—N—C-900 indicates that it can be employed in the cathode for direct methanol fuel cell.

The durability of the catalysts has been evaluated by accelerated degradation test (ADT) in both acid and alkaline electrolytes, as shown in FIG. 9. In O₂-saturated 0.5 M H₂SO₄, after 10000 cycles of ADT, for Pt/C, the E_{1/2} was reduced by 133 mV, for PANI-Fe—N—C (pyrolyzed at 900° C.), the E_{1/2} negatively shifted 52 mV. However, even after 30000 cycles of ADT, the E_{1/2} was only reduced by 29 mV, for PANI-FeCe—N—C. Comparing with the control samples, the reduction in E_{1/2} is mild. The result indicates the incorporation of Ce into the catalyst will greatly enhance the durability. However, in O₂-saturated 0.1 M KOH, PANI-Fe—N—C-900 presents the highest durability instead of PANI-FeCe—N—C-900. After 10000 cycles of ADT, the Eva of PANI-Fe—N—C-900 dropped 17 mV, which is significantly lower than that of Pt/C (101 mV). The reduction in E_{1/2} for PANI-Fe—N—C-900 in alkaline is lower than the reduction observed when the catalyst is in acid, indicating that PANI-Fe—N—C-900 experienced different degradation modes in acidic and in alkaline environments. For PANI-FeCe—N—C-900, its durability is poor comparing with PANI-Fe—N—C-900. This may be caused by the high HO₂⁻ yield during the ADT. HO₂⁻ may generate free radicals that can attack ionomer and carbon matrix, leaching Fe from the active sites which can catalyse the Fenton reactions.

According to the improved fuel cell invention, the precious metal catalysts (currently 60% Pt/C, 0.5 mg cm-2) at the cathode will be replaced by non-precious metal catalysts (Fe—N—C, more preferably FeCe—N—C) to lower the cost of the stack. Some embodiments will employ spraying or slurry coating as the preferred deposition strategy for a scalable and uniform catalyst layer.

In the most preferred embodiment, the improved fuel cell will combine the novel housing construction, flow and air channels, and the novel catalyst.

This step will assess its performances and durability in an aggressive environment, with fluctuations in stack temperature (20-50° C.) and hydration from fully dry to humidified during operations. Once the catalysts are successfully optimized, scale4up and tested in the 5-cell stack with a surface area of 12.5 cm², the catalyst synthesis will be scale4up again, alongside the deposition procedure, to operate the catalyst in the 20-cell stack, with a surface area of 50-100 cm². Also, a cost analysis will be achieved to demonstrate the benefits of the non-precious metal catalysts. If indeed non-precious metal catalysts have a lower activity than Pt/C, on the other hand, the cost reduction may justify building an even more powerful stack, yet less expensive stack to reach the same power target at the 20-cell, Pt/C stack. With the voltage/power characteristics determined, the 20-cell stack will be operated to power an application.

For this approach, it is essential to operate the stack in its ohmic region (0.7 V-0.5 V per cell) to ensure that stability and durability are maintained. The voltage/power curve will correspond to the requirements to be met by device, by adjusting the number of cells if necessary.

With its innovations in membrane, designs, and new catalysts and showcasing its performances on a real application, this stack will present several significant innovations, and the future development planned in the future work will place it as a world leader in hydrogen fuel cell technology.

Variations and modifications may be made to the parts previously described without departing from the spirit or ambit of the disclosure.

The fuel cell structure herein disclosed may be used with hydrogen fuel cells. However, it may be used with a fuel cell using another fuel type.

In one form of constructing the embodiment depicted in FIG. 1, the hydrogen inlet and outlet lines 108, 110 are connected to the outer plate 104 using commercial push-fit connectors. The hydrogen inlet 108 and outlet 110 are on the same outer plate 104. However, it is possible to install them on different outer plates. For instance, the exhaust outlet 110 can be installed on the outer plate 106 which in use will be located on the bottom, allowing for the utilization of gravity to remove the water condensation there-through, which can be substantial. The current collectors can be constructed from copper plates. They can further be plated, e.g., gold-coated, for additional conductivity. The voltage sensor, inserted in the side of each graphite plate (FIG. 3 shows apertures 214 provided to enable the insertion), has two electrical wires soldered to them to detect the voltage differences between two fuel cells.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A fuel cell apparatus, comprising:
at least one fuel cell, comprising two bipolar plates, one providing an anode side, and the other providing a cathode side, the fuel cell being configured to have a fuel inlet and a fuel outlet, and a membrane electrode assembly disposed between the fuel inlets and fuel outlets of the bipolar plates;
the at least one fuel cell being retained by a housing, the housing comprising a first outer plate and a second outer plate, each located on an opposite face of the at least one fuel cell;
the housing further comprising a cooling element support which is adapted to support one or more fans that are adapted to provide an air flow toward the at least one fuel cell.

2. The fuel cell apparatus of claim 1, comprising a stack of multiple fuel cells.

3. The fuel cell apparatus of claim 1, wherein the cooling element support is adapted to be disposed in a transverse orientation to the first and second outer plates, by being attached to each of the first and second outer plates, along a first edge portion of the first outer plate and a first edge portion of the second outer plate.

4. The fuel cell apparatus of claim 3, wherein the cooling element support or the first edge portions of the first and second outer plates, or both, are provided with elongated attachment apertures.

5. The fuel cell apparatus of claim 3, wherein the housing further comprises guide portions, one located on either side of the cooling element support portion, the guide portions defining a location therebetween for the placement of the fuel cell.

6. The fuel cell apparatus of claim 5, wherein the guide portions are adapted to be oriented transverse to the outer plates, by being attached along second and third edge portions of the outer plates, the second and third edge portions being each adjacent to the first edge portions.

7. The fuel cell apparatus of claim 6, wherein the guide portions or the outer plates at the second and third edge portions thereof, are provided with elongate attachment apertures.

8. The fuel cell apparatus of claim 1, wherein at least one or more of the bipolar plates includes a plurality of air channels arranged to receive an air flow, said air channels being generally in axial alignment with said air flow, each air channel having a cross section defined at least in part by a width.

9. The fuel cell apparatus of claim 8, wherein the air channels are provided on a cathode side of each plate.

10. The fuel cell apparatus of claim 8, wherein adjacent air channels are separated by a landing, the landing having a width which is one to two times of the width of the air channels, and wherein a width to depth ratio of the cross section of each air channel is between 1:1 and 1:2.5.

11. (canceled)

12. The fuel cell apparatus of claim 1, wherein at least one or more the bipolar plates include recesses which define a fuel flow field defined between the inlet and outlet.

13. The fuel cell apparatus of claim 12, wherein the fuel flow field is located on an anode side of the plate.

14. The fuel cell apparatus of claim 12, wherein the fuel flow field comprises a plurality of flow channels extending in a direction transverse to a direction of the air flow direction from the one or more fans.

15. The fuel cell apparatus of claim 14, wherein adjacent ones of said flow channels are separated by a landing, the landing having a width which is one to two times of a width of the flow channels as measured transversely across the flow channels.

16. The fuel cell apparatus of claim 14, wherein the flow channels are not connected with each other, or wherein at least some of the flow channels are parts of a continuous channel which includes one or more turns or bends.

17. (canceled)

18. The fuel cell apparatus of claim 1, wherein the or each fuel cell includes a gasket assembly located between the bipolar plates.

19. The fuel cell apparatus of claim 18, wherein the gasket assembly includes an anode gasket adapted to be attached to the anode side, and a cathode gasket attached to be attached to the cathode side, and further including reinforcement layers between the anode gasket and the anode side to avoid bending of the anode gasket over the fuel flow field.

20. (canceled)

21. The fuel cell apparatus of claim 18, wherein the gasket assembly includes one or more alignment gaskets, each having two sides, each side having an adhesive or bonding material.

22. (canceled)

23. The fuel cell assembly of claim 1, wherein each bipolar plate includes attachment openings arranged adjacent the fuel inlet and attachment openings arranged adjacent the fuel outlet.

24. The fuel cell assembly of claim 1, wherein the membrane electrode assembly comprises a catalyst material which is non precious-metal based, wherein the catalyst is a polyaniline (PANI)-derived catalyst with dual active centre.

25. (canceled)

26. (canceled)

27. The fuel cell assembly of claim 24, wherein the catalyst is denoted as PANI-FeₓCe—N—C.

28. The fuel cell assembly of claim 27, wherein the catalyst is pyrolyzed at a temperature between 700 and 100 degrees Celsius.

29. (canceled)
